(19) United States
(12) Patent Application Publication
(10) Pub. No.: US 2015/0304036 A1
(43) Pub. Date: Oct. 22, 2015

(54) Interleaved Bidirectional Sub-Nyquist Transmission with Overlapping Counter-Propagating Signal Spectral Bands

(71) Applicant: NEC Laboratories America, Inc., Princeton, NJ (US)

(72) Inventors: Yue-Kai Huang, Princeton, NJ (US); Shaoliang Zhang, Princeton, NJ (US); Fatih Yaman, Monmouth Junction, NJ (US); Ezra Ip, Plainsboro, NJ (US)

(21) Appl. No.: 14/689,099

(22) Filed: Apr. 17, 2015

Related U.S. Application Data
(60) Provisional application No. 61/980,815, filed on Apr. 17, 2014.

(51) Int. Cl. H04B 10/2507; H04B 10/25; H04J 14/02

(52) U.S. Cl. CPC H04B 10/25073; H04J 14/0234; H04B 10/2503

(57) ABSTRACT

A controller for generating higher fiber spectral efficiency without using high-order modulation formats includes operating an interleaved bidirectional transmission IBT with sub-Nyquist optical regime exchange reach for spectral efficiency.

### RELATED APPLICATION INFORMATION

This application claims priority to provisional application No. 61/980,815, filed Apr. 17, 2014, entitled “Interleaved Bidirectional Sub-Nyquist Transmission with Overlapping Counter-Propagating Signal Spectral Bands”, the contents thereof are incorporated herein by reference.

### BACKGROUND OF THE INVENTION

The present invention relates generally to optics, and more particularly, to interleaved bidirectional sub-Nyquist transmission with overlapping counter-propagating signal spectral bands.

The following references are noted herein in the background discussion of the application:
[1] T. J. Xia, et. al., “Field Experiment with Mixed Line-Rate Transmission (112-Gb/s, 450-Gb/s, and 1.15-Tb/s) over 3,560 km of Installed Fiber Using Filterless Coherent Receiver and EDFAs Only,” OFC/NFOEC 2011, PDPA3, Los Angeles, Calif., March 2011.
[2] Y. K. Huang, et. al., “Real-Time 400 G Superchannel Transmission using 100-GbE based 37.5-GHz Spaced Subcarriers with Optical Nyquist Shaping over 3,600-km DMF link,” OFC/NFOEC 2013, NW4E.1, Anaheim, Calif., March 2013.
[3] J. Yu, et. al., “Field Trial Nyquist WDM Transmission of 833 216.4-Gb/s PDM-CSRZ-QPSK Exceeding 4-b/s/Hz Spectral Efficiency,” OFC/NFOEC 2012, PDP5D.3, Los Angeles, Calif., March 2012.
[4] http://m.huawei.com/enmobile/pr/news/hw-329372.htm
[5] S. Radic et. al, “25 GHz interleaved bidirectional transmission at 10 Gb/s”, Proc. OFC′00, paper OTuC8.
[6] F. Yaman, et. al., “30.6 Tb/s Full-Duplex Bidirectional Transoceanic Transmission Over 75×90.9-km Fiber Spans,” OFC/NFOEC 2014, Th5B.5, San Francisco, Calif., March 2014.

As 100 Gb/s systems are being commercially deployed, new technologies which enable beyond 100-Gb/s channel capacity have generated tremendous interests in recent years. One of the main targets in these technologies is to achieve higher spectral efficiency than the current 2 b/s/Hz provided by the 100-Gb/s channels under 50-GHz dense wavelength division multiplexing (DWDM) spacing. By moving from dual-polarization quadrature phase shift keying (DP-QPSK) to multi-dimensional modulation formats with multilevel signaling, higher spectral efficiency can be achieved by increasing the number of bits transmitted per symbol at the cost of lower tolerance to optical signal-to-noise ratio (OSNR). For example, DP 16-ary quadrature-amplitude modulation (DP-16QAM), one of the potential candidates for short-reach 400 G transmission, can double the spectral efficiency to 4 b/s/Hz under the current 50-GHz DWDM channel spacing by using two optical carriers. However, the large constellation of DP-16QAM requires much higher OSNR, and is more sensitive to fiber nonlinearity and laser phase noise, limiting the system reach over legacy fiber link such dispersion managed fiber (DMF).

Several techniques have been reported to improve spectral efficiency without having to increase signal constellation. The most prominent and promising approach is to employ so-called “Nyquist superchannel” or “Nyquist WDM.” In these approaches, individual optical carriers or optical channels undergo “Nyquist” spectral shaping, a process aimed to concentrate and confine the optical signal energy within or slightly above a theoretical bandwidth limit without incurring penalty from inter-symbol interference (ISI), so that the carrier/channel spacing can be reduced to improve spectral efficiency. Nyquist shaping can be performed either digitally or optically, and the output optical spectrum typically exhibits a rectangular profile for improving OSNR and nonlinear (NL) tolerance. However, the spectral efficiency achievable by Nyquist superchannel and Nyquist WDM also has a limit, as the carrier/channel spacing cannot be reduced to lower than the individual carrier/channel symbol rate [1,2]. For example, the highest practical spectral efficiency is about 3.33 b/s/Hz for Nyquist WDM by fitting the 32-Gbaud channel in 33-GHz spacing.

Some have investigated the possibility of further reducing the carrier spacing to below the Nyquist bandwidth limit. The so-called “sub-Nyquist” multiplexing method will perform sharp filtering on each individual sub-carrier at the transmitter side so the bandwidth of individual subcarriers will be smaller than their corresponding symbol rate [3,4]. The filtering will introduce large penalty at the receiver side due to ISI if standard linear equalizer is used. Therefore, to recover part of the penalty, much more complex DSP, such as maximum likely hood sequence estimation (MLSE), has to be used. Typically, 4 b/s/Hz of spectral efficiency can be achieved by “sub-Nyquist” multiplexing, doubling the numbers of the current 100 G systems. For practical implementation, first the current standard DSP chips will have to be redesigned to accommodate these complex receiver DSP algorithms, which will likely drive up the gate counts and power consumption. Another concern is that most commercial clock recovery circuit (CRC) uses the B/2 frequency component, where B is the signal baud-rate, to recover the clock at the receiver side. For sub-Nyquist multiplexing, this frequency component will no longer be available so new CRC needs to be redesigned. Lastly but most importantly, the early “sub-Nyquist” investigations didn't compare the transmission performance with Nyquist WDM system using QAM modulation format with comparable spectral efficiency. Applicant's internal investigation has found that DP-8QAM Nyquist WDM can achieve similar or even better performance compare to sub-Nyquist multiplexing under the same spectral efficiency by just using standard commercial DSP.

Accordingly, there is a need for a solution that achieves higher fiber spectral efficiency without using high-order modulation formats.

### BRIEF SUMMARY OF THE INVENTION

The present invention is directed to a controller for generating higher fiber spectral efficiency without using high-order modulation formats. The controller includes operating an interleaved bidirectional transmission IBT with sub-Nyquist optical regime exchange reach for spectral efficiency.

In a similar aspect of the invention, there is provided a method for generating higher fiber spectral efficiency without using high-order modulation formats. The generating includes operating an interleaved bidirectional transmission IBT with sub-Nyquist optical regime exchange reach for spectral efficiency.

In yet another similar aspect of the invention, there is provided an optical network including an optical network of

These and other advantages of the invention will be apparent to those of ordinary skill in the art by reference to the following detailed description and the accompanying drawings.

### BRIEF DESCRIPTION OF THE DRAWINGS

FIG. 1 shows a comparison of a fiber pair operating with (a) unidirectional traffic and (b) interleaved bidirectional traffic IBT.

FIG. 2 shows IBT operated at sub-Nyquist channel spacing.

FIG. 3 shows single Rayleigh introduced noise in Sub-Nyquist IBT due to spectral overlapping.

FIG. 4(a) shows experimental spectrum investigating Rayleigh scattering penalty for sub-Nyquist IBT using 100 G channels at 25 GHz spacing.

FIG. 4(b) bit error rate BER versus Rayleigh scattering ration under different OSNRs.

FIG. 5 shows key aspects of the inventive IBT operation in the sub-Nyquist regime.

FIG. 6 is a diagram of an exemplary computer or controller for implementing the invention.

### DETAILED DESCRIPTION

The present invention is different from traditional unidirectional transmission techniques. The present invention utilizes bidirectional transmission with the optical carriers or channels arranged in an interleaved fashion for each direction. For each carrier/channel, its immediate neighbors will be travelling at an opposite direction. Compared to unidirectional transmission, if the channel spacing is reduced below the Nyquist limit, the inter-carrier/channel cross-talks will be much less in bidirectional transmission. Therefore, there can be a reduction in the spacing of the counter-propagating carriers/channels with overlapping spectral bands and still be able to support long-distance transmission to improve overall spectral efficiency.

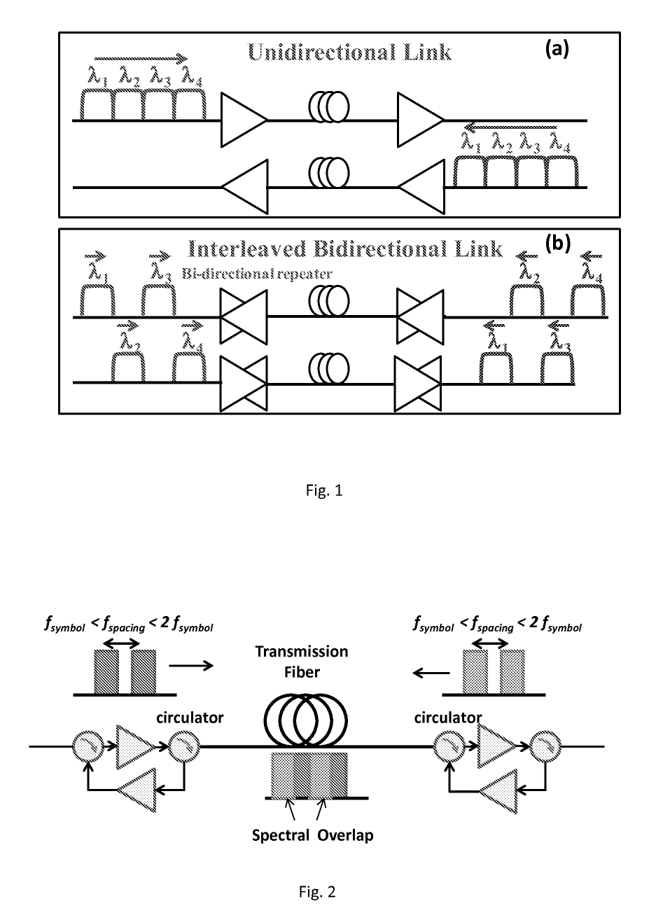

FIG. 1 shows a comparison of a fiber pair operating with (a) unidirectional traffic and (b) interleaved bidirectional traffic IBT. Instead of grouping the WDM channels bound for one direction into one of the fibers, they can be interleaved and transmitted in the same fiber in opposite directions. Comparing the (a) and (b) of FIG. 1, it can be seen that the total traffic traveling in each direction remains the same. The bidirectional link requires a modified repeater.

FIG. 1 compares the operation of unidirectional and bidirectional transmission using a single fiber pair. For unidirectional transmission, a fiber pair is necessary to achieve two-way communication between the terminal ends, and each fiber is dedicated to transmitting traffic either only in the west-to-east (WE) or east-to-west (EW) direction. In interleaved bidirectional transmission (IBT), the same capacity can be achieved by using the fiber pair. The difference is that half of the WE traffic is transmitted in one fiber and the other half is transmitted in the other fiber, while the EW traffic is also shared between the fiber pair in the similar fashion. As a result each fiber carries traffic in both directions making it a bidirectional transmission. If the WE and EW bound carrier/channel wavelengths are arranged in an interleaved manner in the same fiber, as shown in FIG. 1(b), fiber nonlinearity effect can be reduced. That is because the number of channels travelling in the same direction in each fiber is reduced by half along with the fact that the channel spacing is effectively doubled, leading to the suppression of XPM and FWM penalty. If there is no spectral overlap in the bidirectional signal bands, single Rayleigh back-scattering will not be a problem for IBT as it will create only out-of-band noise. Double Rayleigh scattering, which creates noise that is within the signal band, will become a source of penalty at ultra-long distance. However it can be dealt with by placing optical interleaving filters at the repeaters.

FIG. 2 shows IBT operated at sub-Nyquist channel spacing which provides the advantage of supporting 400 G spacing over 100-GHz spacing with DP-QPSK and there is no need for a special CRC process as other sub-Nyquist techniques.

To achieve higher spectral efficiency in IBT, we the invention includes allowing spectral overlapping between the bidirectional propagating channels/carriers, as shown in FIG. 2. With spectral overlapping, the carrier/channel spacing can be effectively reduced to below Nyquist limit, so that more capacity can be supported in the system. When considering one direction only, the spacing between carriers/channels will still be larger than the individual symbol rate, so there is no need to perform sub-Nyquist filtering which can create large ISI penalty and require complex receiver DSP for signal recovery. The repeater design will be the same as the non-overlapped IBT system as each repeater is consist of two unidirectional amplifiers and two 3-port circulators to handle the bidirectional traffics. The overlapping of the spectral bands for the counter-propagating signals, however, will make the single Rayleigh back-scattering an in-band noise source.

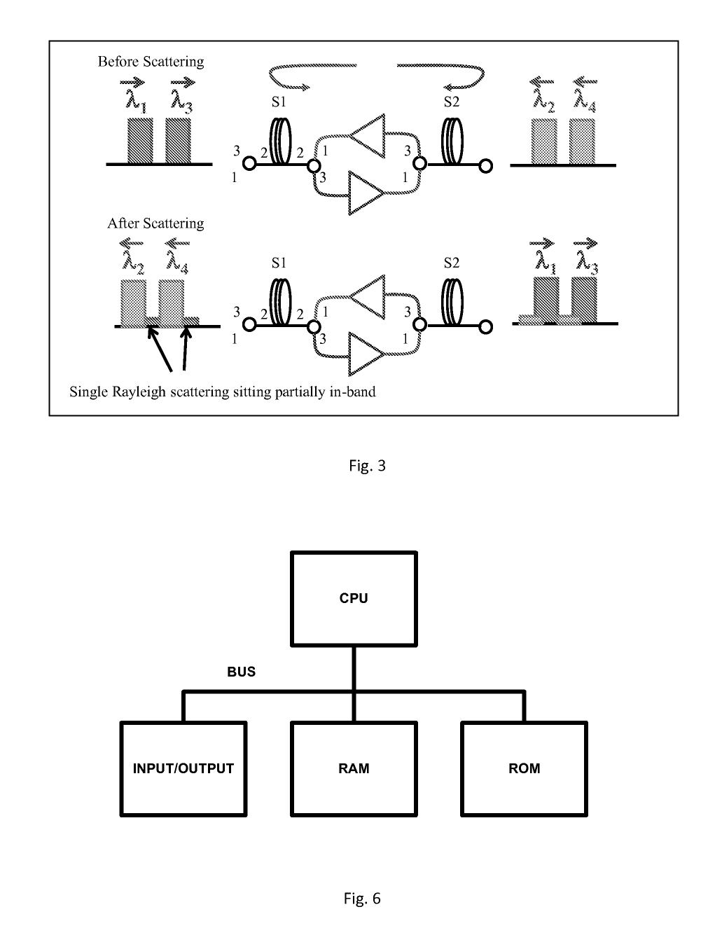

As shown in FIG. 3, the back-scattering of the signal in one direction due to Rayleigh will be partially situated inside the signal band for the other directions because of the overlapping spectral bands. The amount of the Rayleigh scattering will be the additional penalty for operating the IBT in sub-Nyquist regime, and it depends on the fiber type, fiber span loss, transmission distance, and amplification method. In modern fiber systems, Rayleigh scattering can be significantly reduced by the availability of low loss and large-effective area fibers, as well as the use of distributed amplification. From system design's stand point, by operating IBT in sub-Nyquist regime, the designer has the flexibility to trade reach performance for capacity, which is the core philosophy of “variable-rate transmission” in software defined networks (SDN). If a larger capacity is required for a shorter route, the operator can increase the overlapping spectral bands of the sub-Nyquist IBT to squeeze more channels/carriers. The spectral overlapping can also be reduced to grant further transmission distance for lower spectral efficiency. In new generation of transponders with dynamic transmitter-side DSP, designer can also perform optimal digital spectral shaping to make the signal more robust to Rayleigh scattering noise.

For IBT using discrete amplification, the ratio between noise level caused by single Rayleigh backscattering to the signal, P_{srb}/P_{sig} can be expressed as:

$$\frac{{P}_{srb}}{{P}_{sig}} = R \times G \times N$$

where R is the Rayleigh scattering factor per fiber span, G is the amplifier gain, and N is number of fiber spans. For SMF with −82-dB/ns Rayleigh coefficients, an 80-km 16-dB-loss span will create Rayleigh factor of −34.76 dB down. After 12 spans, or equivalent of 960-km, the noise from Rayleigh scattering will be ˜−8 dB.

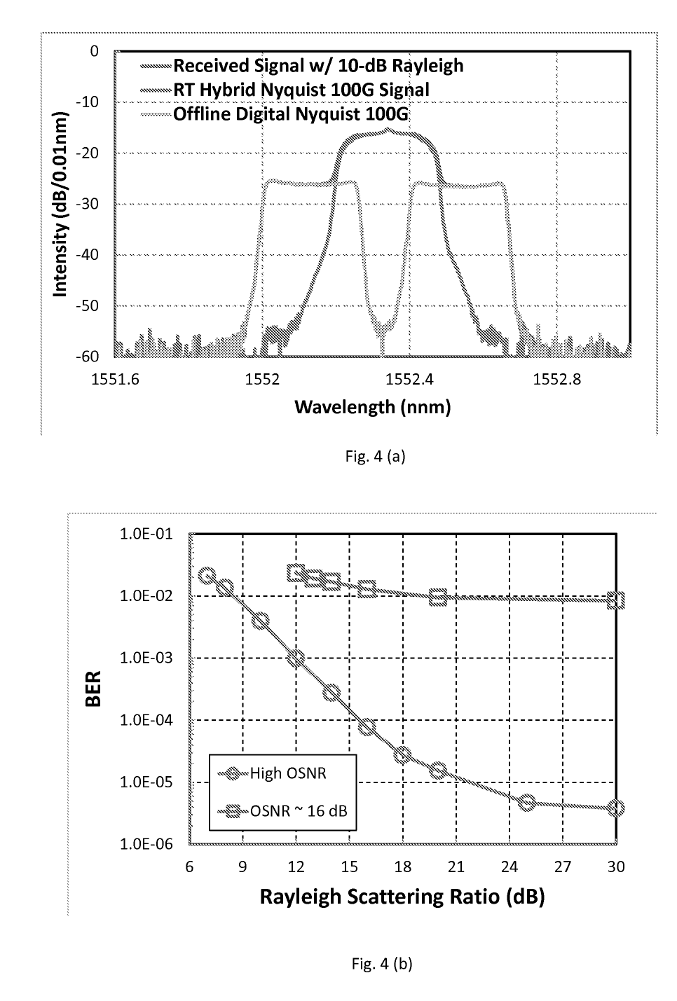

Applicants conducted an experiment to investigate the performance of sub-Nyquist IBT using 100 G DP-QPSK signals, as shown in FIG. 4(a). The three 32-Gbaud 100 G channels were placed 25-GHz apart, clearly below the Nyquist limit, to achieved 4-b/s/Hz spectral efficiency. One real-time 100 G channel (blue) at the center generated using hybrid Nyquist method is used as the test channel. Two offline digitally Nyquist shaped 100 G are used to emulate the Rayleigh back-scattering noise from sub-Nyquist IBT. We plot the received signal BER vs. the Rayleigh scattering ratio in FIG. 4(b) The amount of the Rayleigh scattering the system can tolerate will also depend on the transmission. With a high OSNR (>25 dB), the system can still operate below the SD-FEC limit even with 8 dB Rayleigh scattering ratio.

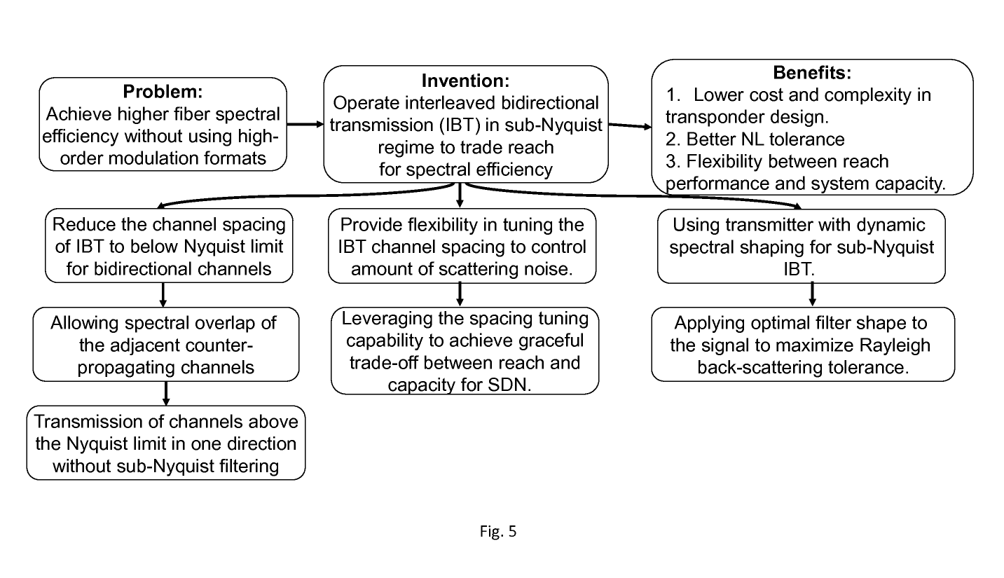

Key aspects of the invention are depicted in FIG. 5. To achieve higher fiber spectral efficiency without using high-order modulation formats the invention operates interleaved bidirectional transmission (IBT) in sub-Nyquist regime to trade reach for spectral efficiency. The invention provides benefits of lower cost and complexity in transponder design, better NL tolerance and flexibility between reach performance and system capacity.

The inventive operation of interleaved bidirectional transmission IBT in sub-Nyquist regime includes reducing channel spacing of the IBT to below Nyquist limit for bidirectional channels, allowing spectral overlap of the adjacent counter propogating channels and transmission of channels above the Nyquist limit in one direction without sub-Nyquist filtering.

The inventive IBT in sub-Nyquist regime includes tuning the IBT channel spacing to control the amount of scattering noise. The spacing tuning capability is leveraged to achieve graceful trade-off between reach and capacity for software defined networks SDN.

The inventive IBT in sub-Nyquist regime includes using the transmitter with dynamic spectral shaping for sub-Nyquist IBT. The dynamic spectral shaping aspect includes applying an optimal filter shape to the signal to maximize Rayleigh back-scattering tolerance.

The invention may be implemented in optical components, controller/computer hardware, firmware or software, or a combination of the three. Preferably, data processing aspects of the invention is implemented in a computer program executed on a programmable computer or a controller having a processor, a data storage system, volatile and non-volatile memory and/or storage elements, at least one input device and at least one output device. More details are discussed in U.S. Pat. No. 8,380,557, the content of which is incorporated by reference.

By way of example, a block diagram of a computer or controller to support the invention is discussed next in FIG. 4. The computer or controller preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

From the foregoing, it can be appreciated that the present invention offers significant advantages.

With the inventive interleaved bidirectional transmission (IBT), sub-Nyquist packing of the counter propagating channels with overlapping spectral bands can be achieved without modifying existing DSP algorithm. It is will be a potentially much simpler transponder design compare to those that required complex DSP algorithms. In fact, one can use the existing 100 G technology to implement an interleaved bidirectional transmission system operating at sub-Nyquist rate to achieve better spectral efficiency without having to re-design the transponder. This will be a huge advantage when looking at the entry cost.

Performance wise, interleaved bidirectional transmission (IBT) enjoys a reduction in fiber nonlinearity (NL) impairments. Wide-band NL penalties such as cross-phase modulation (XPM) and four-wave-mixing (FWM) are effectively less because when considering only one direction, the channel/carrier spacing is effectively larger and the total WDM signal power is less. Therefore, one can design the system such that each carrier/channel to transmit at a higher power to achieve better SNR. Notably, in new digital coherent systems with digital back propagation (DBP), IBT method also makes DBP more effective in removing self-phase modulation (SPM) impairments. [5,6]

One thing that limits the performance of IBT operating in sub-Nyquist regime is the Rayleigh back-scattering of transmission fiber. In normal IBT operation, single Rayleigh scattering will result in out-of-band noise so will not affect transmission performance. For sub-Nyquist IBT, because of the spectral overlap between counter-propagating channels, single Rayleigh scattering will become partially in-band noise, resulting in performance drop. There are different ways to reduce the Rayleigh scattering in fiber link design, including using low loss large effective area fibers, reducing fiber span length, or employing distributed Raman amplification, etc. From the view point of transponder design, our invention can provide the flexibility in graceful trade-off between reach performance and spectral efficiency. By tuning the spacing between the counter-propagating channels, spectral efficiency can be gained at the cost of reducing performance due to larger in-band Rayleigh scattering noise from spectral overlapping.

When the total system cost is considered, sub-Nyquist IBT does not require new investment in transponder design, it will however need bidirectional repeaters to operate. Typically, bidirectional repeaters can be built by using two unidirectional amplifiers with passive circulators (relatively low cost). However, the required amplifier output powers are lower since the numbers of channels are less for both directions, and there is possibility to share the pumps between the two amplifiers. So it is still competitive in terms of overall system cost compare to unidirectional sub-Nyquist systems.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A controller comprising:
a controller for generating higher fiber spectral efficiency without using high-order modulation formats, the controller comprising:
operating an interleaved bidirectional transmission IBT with sub-Nyquist optical regime exchange reach for spectral efficiency.

2. The controller of claim 1, wherein the operating of the IBT comprises reducing channel spacing of the IBT to below a Nyquist limit (sub-Nyquist) for bidirectional channels.

3. The controller of claim 2, wherein the reducing comprises allowing spectral overlap of adjacent counter propagating channels from the bidirectional channels

4. The controller of claim 2, wherein the reducing comprises transmission of channels above the Nyquist limit in one direction without sub-Nyquist filtering.

5. The controller of claim 1, wherein the operating of the IBT comprises providing flexibility in tuning the IBT channel spacing to control scattering noise.

6. The controller of claim 5, wherein the providing flexibility comprises leveraging the spacing tuning for trade-off between reach and capacity for a software defined network.

7. The controller of claim 1, wherein the operating of the IBT comprises using a transmitter with dynamic spectral shaping for the sub-Nyquist IBT.

8. The controller of claim 1, wherein the operating of the IBT comprises applying a preselected filter shape to maximize Rayleigh back-scattering tolerance.

9. The controller of claim 1, wherein the operating of the IBT comprises:
reducing channel spacing of the IBT to below a Nyquist limit (sub-Nyquist) for bidirectional channels;
providing flexible tenability in the channel spacing of the IBT to control scattering noise; and
using a transmitter with dynamic spectral shaping for sub-Nyquist IBT.

10. A method comprising:
generating higher fiber spectral efficiency without using high-order modulation formats,
the generating comprising:
operating an interleaved bidirectional transmission IBT with sub-Nyquist optical regime exchange reach for spectral efficiency.

11. The method of claim 11, wherein the operating of the IBT comprises reducing channel spacing of the IBT to below a Nyquist limit (sub-Nyquist) for bidirectional channels.

12. The method of claim 12, wherein the reducing comprises allowing spectral overlap of adjacent counter propagating channels from the bidirectional channels

13. The method of claim 12, wherein the reducing comprises transmission of channels above the Nyquist limit in one direction without sub-Nyquist filtering.

14. The method of claim 10, wherein the operating of the IBT comprises providing flexibility in tuning the IBT channel spacing to control scattering noise.

15. The method of claim 14, wherein the providing flexibility comprises leveraging the spacing tuning for trade-off between reach and capacity for a software defined network.

16. The method of claim 10, wherein the operating of the IBT comprises using a transmitter with dynamic spectral shaping for the sub-Nyquist IBT.

17. The method of claim 10, wherein the operating of the IBT comprises applying a preselected filter shape to maximize Rayleigh back-scattering tolerance.

18. The method of claim 10, wherein the operating of the IBT comprises:
reducing channel spacing of the IBT to below a Nyquist limit (sub-Nyquist) for bidirectional channels;
providing flexible tenability in the channel spacing of the IBT to control scattering noise; and
using a transmitter with dynamic spectral shaping for sub-Nyquist IBT.
